(19) United States
(12) Patent Application Publication
(10) Pub. No.: US 2021/0322257 A1
(43) Pub. Date: Oct. 21, 2021

(54) Gentle and Flexible Massage Head for Percussion Massager

(71) Applicant: Pado, Inc., Valencia, CA (US)

(72) Inventors: Steven Lee, Valencia, CA (US); Alejandro Garfio, Mission Viejo, CA (US)

(73) Assignee: Pado, Inc., Valencia, CA (US)

(21) Appl. No.: 17/232,003

(22) Filed: Apr. 15, 2021

Related U.S. Application Data
(60) Provisional application No. 63/010,295, filed on Apr. 15, 2020.

(51) Int. Cl. A61H 15/00; A61H 23/00; A61H 23/02

(52) U.S. Cl. CPC A61H 15/0078; A61H 23/006; A61H 23/02; A61H 2201/1676; A61H 2015/0057; A61H 2015/0071; A61H 2201/169; A61H 2015/0042

(57) ABSTRACT

A massage head for use on a percussion massager in order to provide a gentle and body-contour-following massage, includes a plurality of flexible arms extending radially away from the reciprocation axis, and a soft dome made of hollow silicone rubber, soft foam, or the like at the end of each arm. Centrally located among the massage features and on the reciprocation axis is an additional soft dome that is recessed from the massage features, and contacts the skin of the subject being massaged in order to prevent the hard frame of the massage head from “bottoming out” on the subject when the arms flex too much. The massage head also has a ball joint that allows the massage head to pivot relative to the reciprocation axis, allowing the massage head to more closely follow the body contours of the subject.

### CROSS-REFERENCE TO RELATED APPLICATIONS

This application claims benefit of U.S. Provisional Application No. 63/010,295, filed Apr. 15, 2020, which is incorporated herein by reference in its entirety.

### BACKGROUND OF THE INVENTION

### 1. Field of the Invention

This invention relates to the field of percussion massagers. More particularly, this invention relates to the field of a gentle and flexible massage head for percussion massagers.

### 2. Description of Related Art

Electric massage appliances, which will be henceforth referred to simply as “massagers” for ease of discussion, provide both pleasure as well as relief from aching muscles after vigorous sporting activities such as competitive sports or strenuous workouts. The benefits of massage therapy for reducing Delayed Onset Muscle Soreness (DOMS) has been extensively documented in the medical literature since the early 1900's. Massagers can be of the vibration variety, percussion variety, and others. Numerous vibration massagers and percussion massagers in a wide variety of configurations have been designed and sold. Massagers have even been used on animals, as some people have found that their dogs appear to enjoy gentle massages from massagers.

Percussion massagers work by driving a massage head in reciprocating linear motion so that it repeatedly impacts against the muscle or other tissue being massaged. U.S. Patent Publication 2013/0261516 by Cilea for example discloses a battery-operated percussive massager having variable frequency and variable power, and interchangeable massage heads. Cilea's device looks much like a jigsaw such as is typically used in construction work, but modified slightly to provide a percussive massage head at the end of a reciprocating shaft instead of a saw blade. Another example of a percussion massager is presented in patent publication U.S. 2017/0007498 by Park. Both Cilea and Park are incorporated by reference here for their teachings of percussions massagers.

### SUMMARY OF THE INVENTION

The present invention is of a massage head for a percussion or reciprocating massager, that is gentle and flexible, and has an ability to conform to the subject's body contours thereby providing a gentle, even, and pleasing massage to the person or animal being massaged, without the user needing to constantly adjust the angle at which he is holding the massage appliance.

In the discussion that follows the person or animal being massaged will be referred to as the “subject,” and the person holding and directing the massage appliance over the subject's body will be referred to as the “user.”

In an exemplary embodiment the massage head is a massage head that is interchangeable with other massage heads for a percussion or reciprocating massager. The massage head has frame, the frame having a plurality of flexible arms such as three arms, and a soft massage feature such as a foam or air-filled dome or hemisphere on the end of each arm. The soft massage features will be referred to as a “massage balls” for short. The degree of flexing in the arms depends in part on the speed or frequency of the reciprocation from the massage appliance. Because the arms are flexible, the massage head contours easily to the subject's body parts being massaged, and exert only gentle pressure on discontinuities such as bony areas of the subject's body.

Additionally, in the center of the massage head is another soft ball which will be called the center ball, which is recessed back from the farthest extent of the three massage balls. The center ball ensures that even if the user presses the massager hard enough against a body part that one of the arms and its associated massage balls flexes too much, the center ball then contacts the subject rather than any part of the hard plastic frame of the massage head “bottoming out” on the body part especially a bony body part which would be uncomfortable for the user.

Still further, in the preferred embodiment the shaft that connects the massage head to the massage appliance reciprocating shaft has a ball joint that pivots in two rotational directions. This feature allows the massage head to better follow the contours of the body of the subject without the user needing to constantly adjust the angle at which he is holding the massage appliance as he moves the massage head over the subject's body.

Exemplary embodiments of the invention will be further described below with reference to the drawings, in which like numbers refer to like parts. The drawing figures might not be to scale, and certain components may be shown in generalized or schematic form and identified by commercial designations in the interest of clarity and conciseness.

### BRIEF DESCRIPTION OF THE DRAWINGS

FIGS. 1-4 are different views of an exemplary embodiment of the massage head of the present invention.

FIG. 5 is an additional view of the embodiment of FIG. 1 with ghost images added to illustrate both the pivoting action of the pivot joint 16, and the flexing of the flexible arms 22.

FIG. 6 is a bottom view of the embodiment of FIG. 1

FIG. 7 is a side cutaway view of the embodiment of FIG. 1.

FIG. 8 is an illustration of the massage head of FIG. 1 when attached to a massager, and being used on a massage subject.

### DETAILED DESCRIPTION OF THE PREFERRED EMBODIMENTS

The massage head of the present invention can be used with a percussion massager of the type disclosed by Park. It could be attached to the reciprocating output shaft of Park by any one of various attachment means, including a screw thread, and quick release employing a spring-biased ball such as is commonly used in socket wrench sets, or a sliding collar locking mechanism similar to that used on compressed air attachment mechanisms, or various other mechanisms.

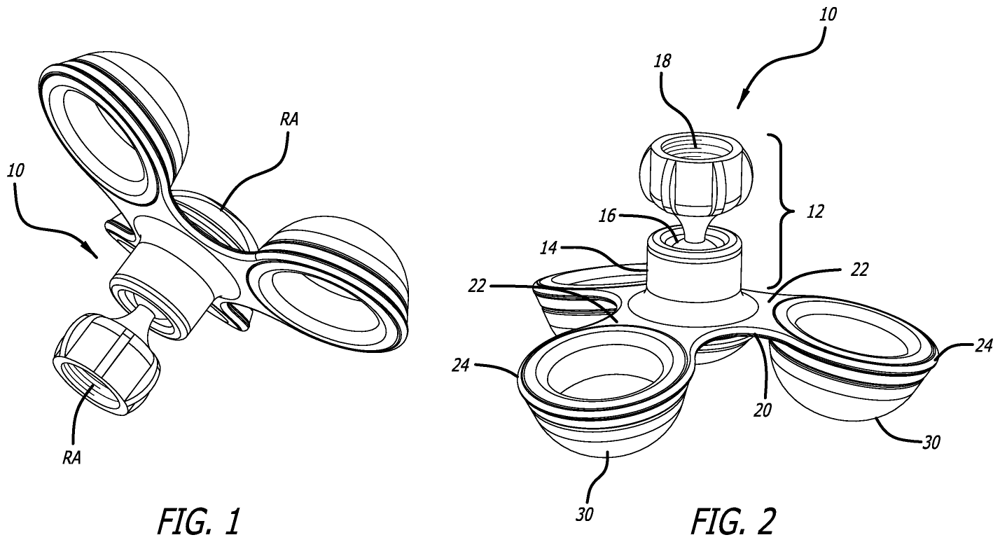

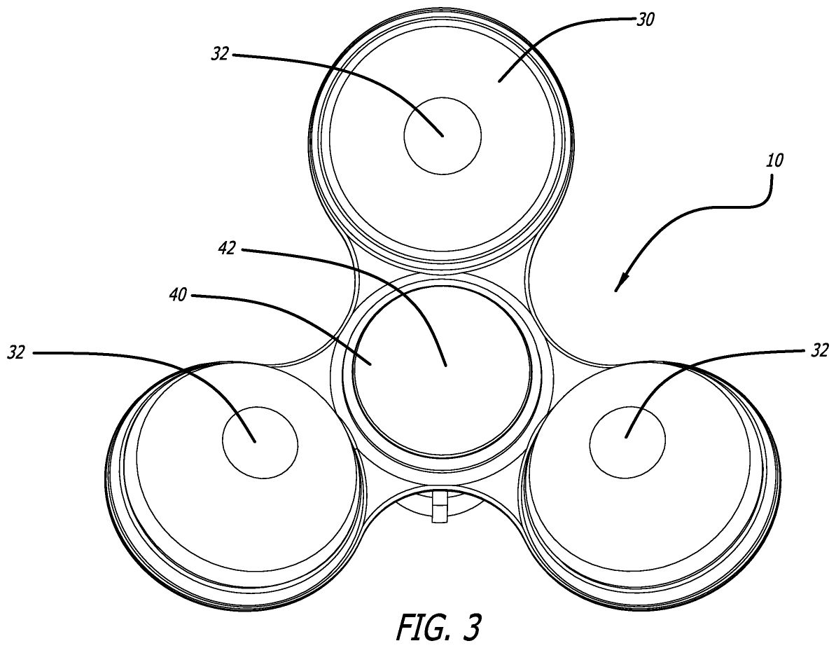

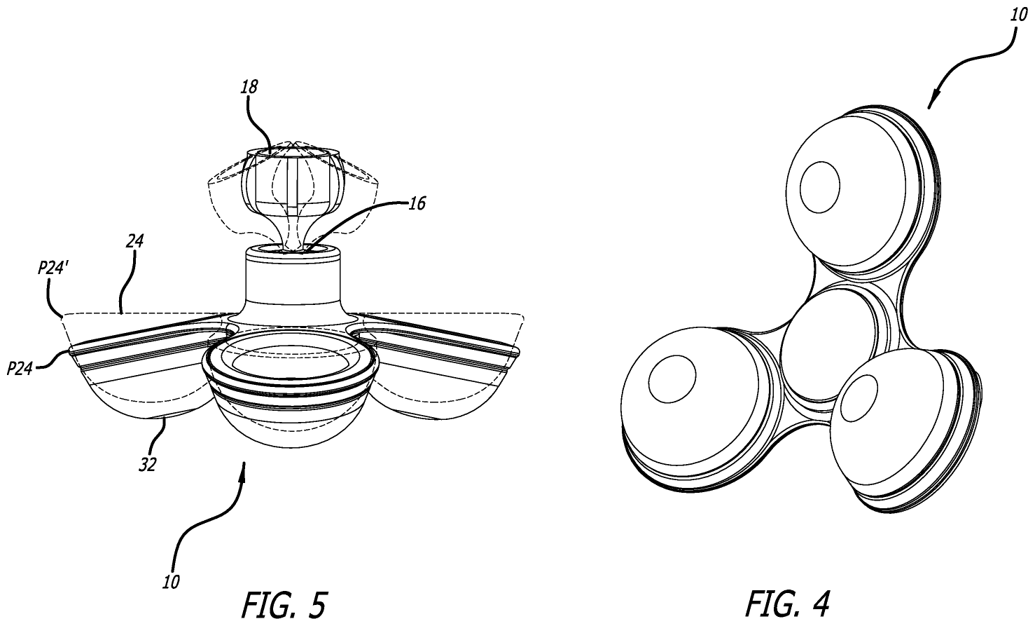

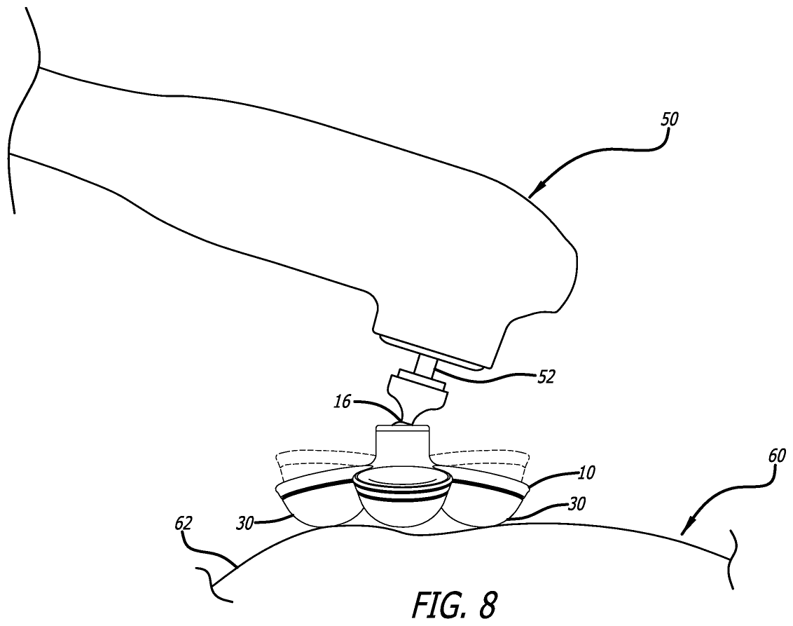

FIGS. 1-4 are different views of an exemplary embodiment of the massage head of the present invention. Flexible percussion massage head 10 includes a connector portion 12 having a neck 14, a pivot joint 16 such as the ball joint shown, and a female receptor 18 for receiving the reciprocating output shaft 52 of the percussion massager 50 (FIG. 8) to which the head will be attached. When massage head 10 is attached to the output shaft of the percussion massager, massage head 10 reciprocates along reciprocation axis RA.

Ball joint 16 allows head 10 to pivot in two rotational directions relative to the percussion massager's output shaft, allowing all three of the massage features 30 to be pressed up against the subject's body portion to be massaged without the percussion massager needing to be held exactly perpendicular to that body portion. The user can thus move the massager around over various body parts without needing to constantly and exactly adjust the angle at which he holds the massager as the body contours beneath the massager change.

Massage head 10 further includes a frame 20 which in this embodiment is a plastic frame. Frame 20 includes a number of flexible plastic arms 22 having round rings 24 at the ends of arms 22. In this embodiment massage head 10 includes three flexible arms, although the number of flexible arms could be more than, or less than, three. Fitted into rings 24 are massage features 30 which impact the subject's body and provide the massage. In this embodiment massage features 30 are rounded hollow domes made of soft silicone rubber or TPU or TPE, but could be differently shaped and/or made of different material such as closed- or open-cell foam.

In this embodiment the hollow domes 30 are open at their backs. In the anticipated commercial embodiment domes 30 will have a Shore A durometer within the range of about 35-60.

Domes 30 and dome 40 will be referred to as “balls” for ease of discussion, although it is understood that massage ball 30 and central ball 40 are not full spheres but only portions of spheres or other rounded shapes i.e., are only sections of generally but not necessarily sphere-shaped objects. Massage feature 30 can have any of a number of shapes having convex outer surfaces.

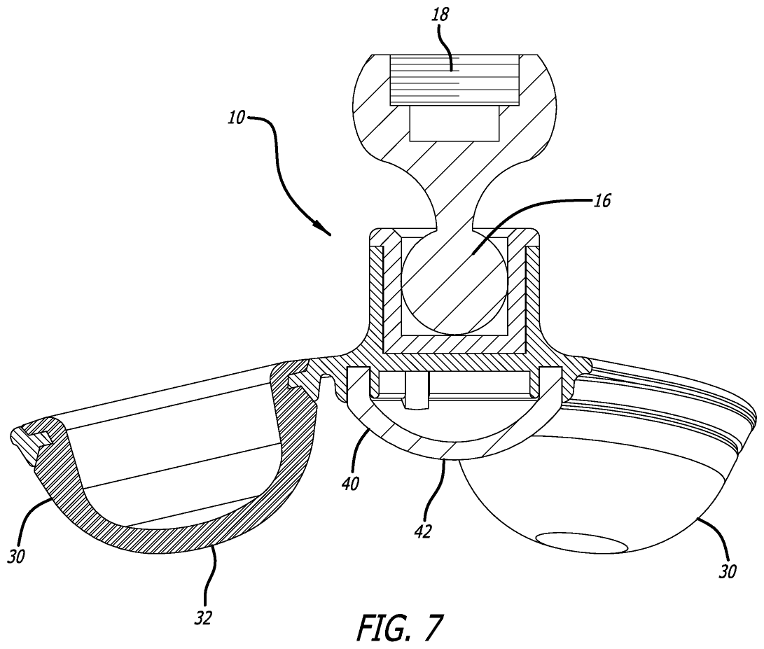

Centrally located relative to massage ball 30 is a resilient central ball 40 which is also a resilient hollow dome made of soft silicone rubber. In this embodiment central ball 40 is closed, or nearly completely closed, at the back, but is flatter than massage balls 30. It is anticipated that central ball 40 will be within the range of about 0-20% softer than massage balls 30. Central ball 40 is preferably recessed from massage balls 30. In this embodiment the recess distance SR (FIG. 7) is about 10.5 mm or about 1 cm, but could be within the range of about 6-15 mm, or about 3-20 mm.

In the commercial embodiment massage balls 30 will have a diameter within the range of about 20-40 mm, and more preferably about 26-36 mm, and in particular about 31.5 mm. The center ball 40 will have a diameter of about 15-35 mm, and more preferably about 20-30 mm, and in particular about 24 mm.

FIG. 5 is an additional view of the embodiment of FIG. 1 with ghost images added to illustrate the pivoting action of the pivot joint 16. Ghost images also illustrate the flexing of the flexible arms 22 when massage head 10 is attached to a reciprocating massage appliance 10 and the massage appliance is turned on, causing massage head 10 to reciprocate. During operation flexible arms 22 flex, causing massage balls 30 to “bounce,” i.e., to reciprocate up and down relative to connector portion 12. Massage balls 30 therefore move up and down during operation a greater distance than does connector portion 12, and massage balls 30 therefore strike the target body portion of the subject with greater speed than if arms 22 did not flex. At the same time, the striking can be more gentle due to the arm flexing because the massage ball 30 bounces gently off the body surface rather than being driven into it.

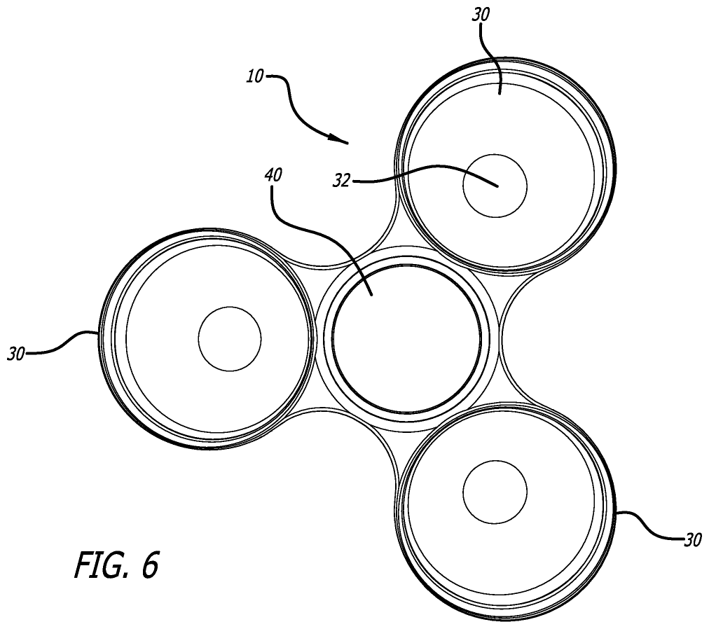

FIG. 6 is a bottom view of the embodiment of FIG. 1

FIG. 7 is a side cutaway view of the embodiment of FIG. 1, with the massage head in its static position, i.e., when it is not being driven by a massage appliance.

In the exemplary embodiment, when the massage appliance 50 drives the massage head 10 at a reciprocation frequency of 60 Hz at an amplitude of ±0.5 cm, the flexible arms flex such that the apexes of massage balls 30 flex or oscillate a distance SF (FIG. 5) at least ±0.5 cm from their static (undriven) positions relative to connector portion 12, and more preferably within the range of ±0.5-4 cm from their static positions, and more preferably still within the range of about ±1-3 cm from their static positions. It is anticipated that in the commercial embodiment the amount of flex will be about ±2 cm from the static positions.

In another aspect, when the output shaft 52 of the massage appliance 50 reciprocates at a frequency of greater than 30 Hz, and at a travel distance of s as measured at the output shaft 52, the flexible arms flex such that the resilient massage features 30 reciprocate with a total travel distance that is at least 1.25 s, and more preferably at least 1.5 s.

Because arms 22 flex, the overall massage head 10 is able to follow contours of the body surface on which it is being used. FIG. 8 is a side view of massage head 10 being used on a body part 62 of a subject 60 having contours. Due to the flexing action of the flexible arms 22 and to the pivoting action of ball joint 16, massage features 30 can maintain more or less uniform contact and massage to body part 62 despite its contours, and despite the reciprocating output shaft 52 being held at an angle relative to the nominal surface of body part 62.

It will be understood that the terms “generally,” “approximately,” “about,” “substantially,” and “coplanar” as used within the specification and the claims herein allow for a certain amount of variation from any exact dimensions, measurements, and arrangements, and that those terms should be understood within the context of the description and operation of the invention as disclosed herein.

It will further be understood that terms such as “top,” “bottom,” “above,” and “below” as used within the specification and the claims herein are terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

It will be appreciated that the term “present invention” as used herein should not be construed to mean that only a single invention having a single essential element or group of elements is presented. Similarly, it will also be appreciated that the term “present invention” encompasses a number of separate innovations which can each be considered separate inventions. Although the present invention has thus been described in detail with regard to the preferred embodiments and drawings thereof, it should be apparent to those skilled in the art that various adaptations and modifications of the present invention may be accomplished without departing from the spirit and the scope of the invention. For example, the massage features could be something other than generally smooth spheres, the massage balls could be made of various different materials, the number of arms and massage features could be different, the degree of flexibility in the arms could be different, and other variations. Accordingly, it is to be understood that the detailed description and the accompanying drawings as set forth hereinabove are not intended to limit the breadth of the present invention, which should be inferred only from the following claims and their appropriately construed legal equivalents.

We claim:

1. A flexible percussion massage head comprising:
a connector portion for connecting to a shaft of a percussion massage appliance, the percussion massage appliance reciprocating along a reciprocation axis;
a frame comprising at least three flexible arms extending away from the reciprocation axis; affixed at the end of each of the flexible arms, a respective soft and resilient massage feature; wherein when the percussion massage appliance supplies a reciprocating motion to reciprocate
the flexible percussion massage head, the flexible arms flex causing the resilient massage features to repeatedly strike a body surface being massaged with greater speed than if the flexible arms were not flexible.

2. A flexible percussion massage head comprising:
a connector portion for connecting to a shaft of a percussion massage appliance, the percussion massage appliance reciprocating along a reciprocation axis;
a frame comprising:
a central portion affixed to the connector portion and disposed on the reciprocation axis; a plurality of flexible arms extending away from the reciprocation axis, the flexible arms
flexing when the massage head reciprocates along the reciprocation axis;
a plurality of resilient massage features mounted to respective ones of the flexible arms.

3. The flexible percussion massage head of claim 2 wherein the resilient massage features comprise rounded convex outer surfaces.

4. The flexible percussion massage head of claim 2 wherein the resilient massage features comprise resilient hollow domes.

5. The flexible percussion massage head of claim 2 said plurality of flexible arms are three in number.

6. The flexible percussion massage head of claim 2 wherein the connector portion includes a swivel connector that allows the frame to pivot in two rotational directions relative to the percussion massage appliance when the connector portion is affixed to the percussion massage appliance.

7. The flexible percussion massage head of claim 6 wherein the swivel connector comprises a ball joint.

8. The flexible percussion massage head of claim 2 wherein the resilient massage features comprise silicone.

9. The flexible percussion massage head of claim 2 further comprising a resilient central feature, the resilient central feature being disposed on the reciprocation axis and centrally disposed relative to the massage features.

10. The flexible percussion massage head of claim 9 wherein the resilient central feature comprises a silicone dome.

11. The flexible percussion massage head of claim 9 wherein a the resilient central feature is recessed relative to the massage features mounted to the flexible arms.

12. The flexible percussion massage head of claim 2 wherein:
the resilient massage features have a Shore A durometer within the range of 35-60.

13. The flexible percussion massage head of claim 2 wherein the flexible arms each comprise:
an arm portion extending in a direction radially away from the reciprocation axis; and a generally circular ring at a distal end of the arm portion; and
wherein each massage feature comprises a resilient dome retained within a corresponding one of the generally circular holes.

14. The flexible percussion massage head of claim 13 wherein each of the resilient domes is removable from its corresponding generally circular hole and replaceable therein.

15. The flexible percussion massage head of claim 2 wherein:
when the massage appliance drives the massage head at a reciprocation frequency of 60 Hz at an amplitude of ±0.5 cm, the flexible arms flex at least ±0.5 cm from their static positions relative to the connector portion.

16. A flexible percussion massage head comprising:
a connector portion for connecting to a shaft of a percussion massage appliance, the percussion massage appliance reciprocating along a reciprocation axis;
a plurality of resilient domes affixed to the connector portion and spaced apart from the reciprocation axis;
a central resilient dome located on the reciprocation axis;
wherein the central resilient dome is recessed relative to the plurality of resilient domes such that an apex of the central resilient dome is located father away from a subject's body surface to be massaged than are respective apexes of said plurality of resilient domes.

17. The flexible percussion massage head of claim 16 further comprising a swivel joint such that the plurality of resilient domes can pivot in two dimensions relative to the reciprocation axis.

18. The flexible percussion massage head of claim 16 wherein the plurality of resilient domes are disposed proximate the ends of respective flexible arms that extend radially away from the reciprocation axis.

19. A flexible percussion massage head comprising:
a connector portion for connecting to a shaft of a percussion massage appliance, the percussion massage appliance reciprocating along a reciprocation axis;
a frame comprising a plurality of flexible arms extending away from the reciprocation axis; affixed on each of the flexible arms, a respective resilient massage feature;
wherein when the percussion massage appliance supplies a reciprocating motion to reciprocate the flexible percussion massage head at a frequency of greater than 30 Hz and over a travel distance of s as measured at the shaft of the percussion massager, the flexible arms flex causing the resilient massage features to reciprocate with a total travel distance that is at least 1.25 s.
